(19) United States
(12) Patent Application Publication
(10) Pub. No.: US 2017/0167680 A1
(43) Pub. Date: Jun. 15, 2017

(54) VEHICLE LIGHTING ASSEMBLY AND METHOD

(71) Applicant: Honda Motor Co., Ltd., Tokyo (JP)

(72) Inventors: Craig Mitchell, Huntington Beach, CA (US); Jeffrey Grix, Long Beach, CA (US)

(21) Appl. No.: 14/966,090

(22) Filed: Dec. 11, 2015

(51) Int. Cl. F21S 8/10; F21V 8/00; B60Q 3/00

(52) U.S. Cl. CPC F21S 48/00; B60Q 3/004; G02B 6/0008; F21Y 2115/10

(57) ABSTRACT

A vehicle lighting assembly and method includes an LED light source mounted on a vehicle and a multi-tube condensing structure arranged to condense light from the LED light source. The multi-tube condensing structure has a first end face for receiving light from the LED light source and a second end face spaced apart from the first end face for dispersing the light received from the LED light source. The first end face has a first end face surface area and the second end face has a second end face surface area. The second end face surface area is less than the first end face surface area to thereby condense the light received from the LED light source.

### BACKGROUND

Conventionally, a lighting device is known, which includes a light source unit integrally having a light source formed by an LED (light-emitting diode) element and a heat sink configured to cool the LED light source. Increasingly, LED light sources have been applied to vehicles to provide primary lighting for the vehicle (e.g., within headlights or forward operating lights for the vehicle). In addition, LED light sources are used elsewhere on the vehicle (e.g., within the vehicle cabin, such as for illuminating the dashboard, providing interior vehicle lighting, etc.). As LEDs have been utilized to an increasing degree on vehicles, there remains opportunities for improving operation and/or styling of such LED lighting assemblies on vehicles.

### BRIEF DESCRIPTION

According to one aspect, a vehicle lighting assembly includes an LED light source mounted on a vehicle and a multi-tube condensing structure arranged to condense light from the LED light source. The multi-tube condensing structure has a first end face for receiving light from the LED light source and a second end face spaced apart from the first end face for dispersing the light received from the LED light source. The first end face has a first end face surface area and the second end face has a second end face surface area. The second end face surface area is less than the first end face surface area to thereby condense the light received from the LED light source.

According to another aspect, a lighting assembly for a vehicle includes an LED array for providing lighting on the vehicle and a condensing structure having a first end face receiving light emitted by the LED array and a second end face for releasing light from the LED array. The condensing structure transports the light from the first end face to the second end face and condenses the light to thereby increase brightness of the light at the second end face. The second end face has a surface area that is less than that of the first end face.

According to a further aspect, a vehicle lighting method includes providing an LED light source and condensing light from the LED light source through a multi-tube condensing structure comprising a plurality of light guide tubes.

### BRIEF DESCRIPTION OF THE DRAWINGS

FIG. 1 is a schematic cross-sectional view of a vehicle lighting assembly according to an exemplary embodiment.

FIG. 2 is a perspective view of a multi-tube condensing structure according to an exemplary embodiment.

FIG. 3 is a perspective view similar to FIG. 2 but shown in partial cross section to illustrate light tubes of the multi-tube condensing structure.

FIG. 4 is an end view showing a first end face of the multi-condensing structure and particularly showing spacing between the light tubes of the multi-tube condensing structure.

FIG. 5 is a perspective view of a multi-tube condensing structure according to an alternate exemplary embodiment.

FIG. 6 is a schematic block diagram showing a vehicle lighting method according to an exemplary embodiment.

### DETAILED DESCRIPTION OF THE EMBODIMENTS

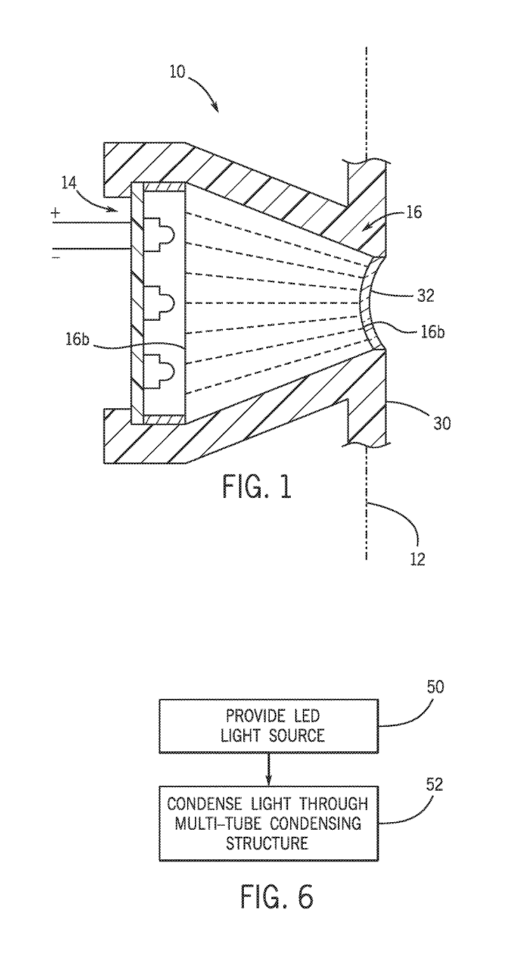

With reference now to the drawings wherein the figures are for purposes of illustrating one or more exemplary embodiments and not for purposes of limiting the same, FIG. 1 schematically illustrates a vehicle lighting assembly for a vehicle with the vehicle lighting assembly generally designated by reference 10. The vehicle lighting assembly 10 includes an LED light source 14 mounted on the vehicle 12 and a condensing structure 16 arranged to condense light from the LED light source 14. In one exemplary embodiment, the LED light source 14 is an LED array for providing lighting on the vehicle 12. For example, the lighting on the vehicle 12 can be any lighting on the vehicle 12, including exterior lights (e.g., headlights, taillights, turn signals, etc.), vehicle cabin lighting (e.g., dome lighting, door lighting, cargo area lighting, tailgate or hatchback lighting, etc.), instrument and/or accessory lighting (e.g., on the dashboard of the vehicle, and the console area of the vehicle, etc.), ambient lighting and/or any other lighting on the vehicle. As described in more detail below, the condensing structure 16 can be a multi-tube condensing structure that condenses light received from the LED light source 14 and provides a brighter and/or more focused light.

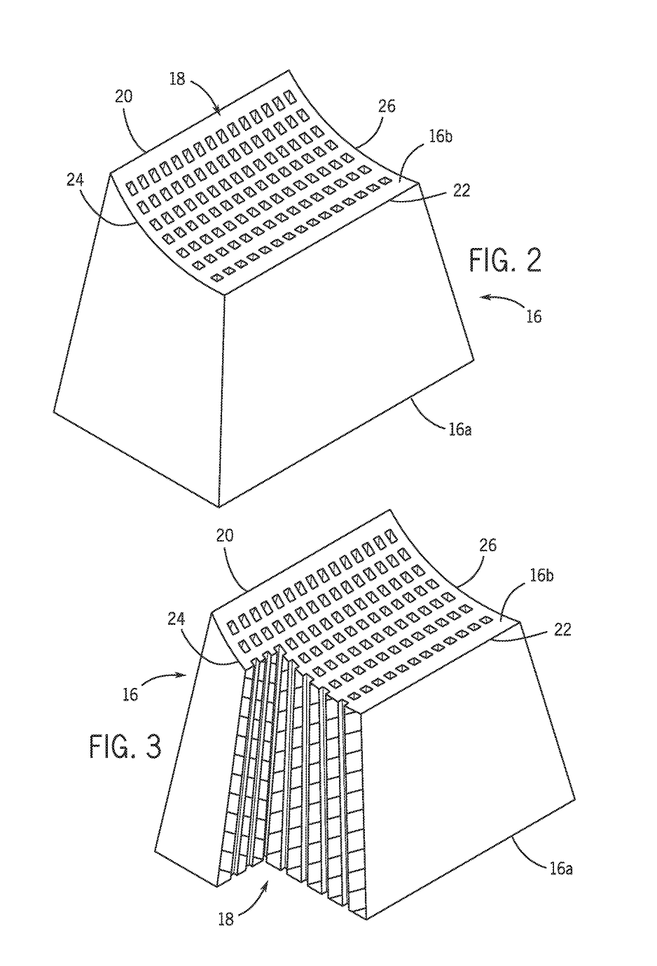

With additional reference to FIG. 2, the condensing structure 16 has a first end face 16a for receiving light from the LED light source 14 and a second end face 16b spaced apart from the first end face 16a for dispersing the light received from the LED light source 14. Thus, the first end face 16a of the condensing structure 16 receives light emitted by the LED light source 14 and the second end face 16b of the condensing structure 16 releases light from the LED light source 14. The first end face 16a has a first end face surface area SA1 and the second end face 16b has a second end face surface area SA2. The second end face surface area SA2 is less than the first end face surface area SA1 to thereby condense the light received from the LED light source 14. Thus, the condensing structure 16 transports light from the first end face 16a to the second end face 16b and condenses the light to thereby increase brightness of the light at the second end face 16b.

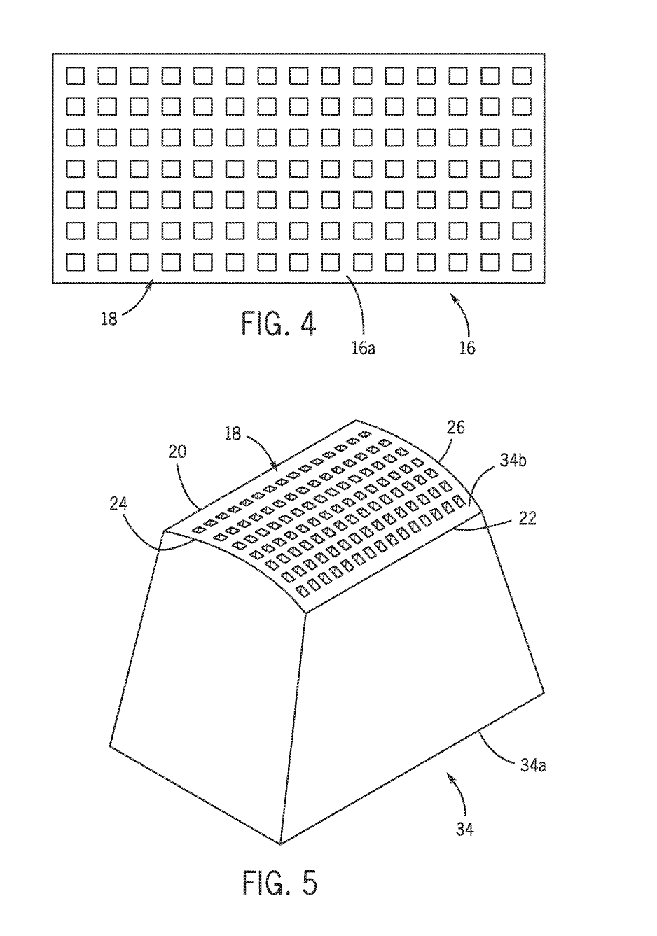

With additional reference to FIG. 3, the condensing structure 16 includes the plurality of light guide tubes 18 extending from the first end face 16a to the second end face 16b. With still further reference to FIG. 4, the density of the plurality of light guide tubes is greater on the second end face 16b than on the first end face 16a. In other words, spacing between adjacent ones of the plurality of light guide tubes 18 is greater on the first end face 16a than on the second end face 16b. This is best shown by comparing FIGS. 2 and 4. By this arrangement, the plurality of light guide tubes are more densely disposed on the second end face 16b than the first end face 16a.

As shown, the condensing structure 16 is generally pyramidal frustum-shaped, though the second end face 16b is not necessarily parallel with the first end face 16a, nor is the second end face 16b necessarily planar. Also in the illustrated embodiment, the first end face 16a of the condensing structure 16 can be a generally flat or planar surface and the second end face 16b of the condensing structure 16 can be a generally curved surface. In particular, the second end face 16b of the condensing structure 16 can be generally concave or convex, and is shown as a generally concave curved surface in the embodiment illustrated in FIGS. 1-4.

With specific reference to FIG. 2, a first pair of opposed edges 20, 22 of the second end face 16b can be linear or straight and a second pair of opposed edges 24, 26 of the second end face 16b can be curved. Also, as best shown in FIG. 2, one of the first pair of opposed edges, such as edge 20, can be spaced apart from the first end face 16a a greater distance than the other of the first pair of opposed edges, such as edge 22. The plurality of light guide tubes 18 each extend from the first end face 16a with each of the plurality of light guide tubes 18 having a rectangular cross-sectional shape (see FIG. 4) in the illustrated embodiment, though this is not required. Each of the plurality of light guide tubes 18 can have a constant cross-section along an entire longitudinal extent thereof (e.g., from the first end face 16a to the second end face 16b).

The LED light source 14 can include a plurality of LEDs 28 (as schematically shown in FIG. 1) arranged to direct light in a direction generally orthogonal relative to the second end face 16b. Though not shown, in one embodiment, the LED light source 14 can include a plurality of LEDs, such as the plurality of LEDs 28, but having each of the plurality of light guide tubes 18 coupled with a unique LED of the plurality of LEDs 28. In particular, one LED can be provided for each light guide tube of the condensing structure 16 in this alternate embodiment.

With specific reference to FIG. 1, the lighting assembly 10 can further include a housing 30 in which the LED light source 14 and the condensing structure 16 are mounted. Optionally, a lens 32 can be provided forward of the condensing structure 16 (i.e., adjacent the second end face 16b). The housing 30 can be a portion of the vehicle 12 or a separately provided housing 30 mounted on the vehicle 12. The housing 30 can be secured to or integrally formed with a portion of the vehicle 12 at which light form the light source 14 is desired. For example, the housing 30 can be formed as part of or connected to the forward bumper area (not shown) of the vehicle 12 to provide light forward of the vehicle (e.g., headlights). Similarly, the housing 30 can be formed as part of or connected to some other exterior area (not shown) on the vehicle 12 to provide exterior illumination (e.g., taillights, exterior ambient or style lighting, turn signals, etc.). Also, the housing 30 can be formed as part of or connected to some interior area (not shown) on the vehicle 12 (e.g., on the dashboard) to provide interior illumination. Generally, anywhere light is provided on the vehicle 12, the housing 30 can be provided.

With reference now to FIG. 5, a condensing structure 34 is shown according to an alternate exemplary embodiment. The condensing structure 34 can be the same or similar as the condensing structure 16 except as noted hereinbelow. One difference with respect to the condensing structure 34 is that second end face 34b has a convex curvature as compared to the second end face 16b having a concave curvature. In most other respects, the condensing structure 34 can be the same or similar as the condensing structure 16.

With reference now to FIG. 6, a vehicle lighting method is illustrated. The vehicle lighting method of FIG. 6 will be described in association with the vehicle lighting assembly 10 already described hereinabove, though this is not required and it is to be understood that the vehicle lighting method can be used with other vehicle lighting assemblies. As shown in FIG. 6, at 50, the method includes providing an LED light source, such as LED light source 14. The method also includes, at 52, condensing light from the LED light source through a multi-tube condensing structure, such as condensing structure 16 or 34, that itself comprises a plurality of light to guide tubes, such as the plurality of light guide tubes 18.

It will be appreciated that various of the above-disclosed and other features and functions, or alternatives or varieties thereof, may be desirably combined into many other different systems or applications. Also that various previously unforeseen or unanticipated alternatives, modifications, variations or improvements therein may be subsequently made by those skilled in the art which are also intended to be encompassed by the following claims.

1. A vehicle lighting assembly, comprising:
an LED light source mounted on a vehicle; and
a multi-tube condensing structure arranged to condense light from the LED light source, the multi-tube condensing structure having a first end face for receiving light from the LED light source and a second end face spaced apart from the first end face for dispersing the light received from the LED light source, the first end face having a first end face surface area and the second end face having a second end face surface area, the second end face surface area less than the first end face surface area to thereby condense the light received from the LED light source.

2. The vehicle lighting assembly of claim 1 wherein the multi-tube condensing structure includes a plurality of light guide tubes extending from the first end face to the second end face.

3. The vehicle lighting assembly of claim 2 wherein a density of the plurality of light guide tubes is greater on the second end face than on the first end face.

4. The vehicle lighting assembly of claim 2 wherein spacing between adjacent ones of the plurality of light guide tubes is greater on the first end face than on the second end face.

5. The vehicle lighting assembly of claim 1 wherein the multi-tube condensing structure is generally pyramidal frustum shaped.

6. The vehicle lighting assembly of claim 1 wherein the first end face of the multi-tube condensing structure is a generally flat surface.

7. The vehicle lighting assembly of claim 1 wherein the second end face of the multi-tube condensing structure is generally a curved surface.

8. The vehicle lighting assembly of claim 1 wherein the second end face of the multi-tube condensing structure is generally concave or convex.

9. The vehicle lighting assembly of claim 1 wherein a first pair of opposed edges of the second end face are linear and a second pair of opposed edges of the second end face are curved, and wherein one of the first pair of opposed edges is spaced apart from the first end face a greater distance than the other of the first pair of opposed edges.

10. The vehicle lighting assembly of claim 1 wherein the LED light source includes a plurality of LEDs arranged to direct light in a direction generally orthogonal relative to the second end face.

11. The vehicle lighting assembly of claim 1 wherein the multi-tube condensing structure includes a plurality of light guide tubes extending from the first end face with each of the plurality of light guide tubes having a rectangular cross-sectional shape.

12. The vehicle lighting assembly of claim 11 wherein the LED light source includes a plurality of LEDs and each of the plurality of light guide tubes is coupled with a unique LED of the plurality of LEDs.

13. A lighting assembly for a vehicle, comprising:
an LED array for providing lighting on the vehicle; and
a condensing structure having a first end face receiving light emitted by the LED array and a second end face releasing light from the LED array, the condensing structure transporting the light from the first end face to the second end face and condensing the light to thereby increase brightness of the light at the second end face, the second end face having a surface area that is less than that of the first end face.

14. The lighting assembly of claim 13 wherein the condensing structure includes a plurality of light guide tubes extending between the first end face and the second end face, the plurality of light guide tubes more densely disposed on the second end face than the first end face.

15. The lighting assembly of claim 14 wherein each of the plurality of light tubes has a constant cross-section along an entire longitudinal extent thereof.

16. The lighting assembly of claim 15 wherein spacing between adjacent ones of the plurality of light guide tubes is greater at the first end face than at the second end face.

17. The lighting assembly of claim 13 wherein the first end face is substantially planar and the second end face is generally curved.

18. The lighting assembly of claim 17 wherein the LED array includes one LED for each light guide tube of the plurality of light guide tubes.

19. A vehicle lighting method, comprising:
providing an LED light source; and
condensing light from the LED light source through a multi-tube condensing structure comprising a plurality of light guide tubes.

20. The vehicle lighting method of claim 19 wherein the multi-tube condensing structure includes a first end face arranged adjacent the LED light source for receiving light from the LED light source and a second end face spaced apart for the first end face, the second end face having a smaller surface area than the first end face so that the plurality of light guide tubes are more densely arranged on the second end face than on the first end face.
